(19) United States
(12) Patent Application Publication
(10) Pub. No.: US 2009/0234638 A1
(43) Pub. Date: Sep. 17, 2009

(54) Use of a Speech Grammar to Recognize Instant Message Input

(75) Inventors: Vishwa Ranjan, Seattle, WA (US); Marcelo Ivan Garcia, Seattle, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 12/048,839

(22) Filed: Mar. 14, 2008

(51) Int. Cl. G06F 17/27; G10L 15/22

(52) U.S. Cl. 704/9; 704/270.1

(57) ABSTRACT

In general, this disclosure describes techniques of using a grammar to identify concepts expressed by audio messages and text messages and to respond to the concepts expressed by the audio messages and the text messages. As described herein, a server may receive audio messages and text messages. The server may use the same grammar to identify concepts expressed in the audio messages and in the text messages. Consequently, there may be no need for different grammars to identify concepts expressed in audio messages and to identify concepts expressed in text messages. After the server identifies a concept expressed in either an audio message or a text message, the server may generate and send an audio message or a text message that includes a response that is responsive to a concept expressed in the audio message or the text message.

### BACKGROUND

Text messaging is a popular method of communication. Individuals can use text messaging to communicate with a wide variety of parties. For example, an individual can use text messaging to communicate with his or her friends. In a second example, an individual can use text messaging to communicate with an enterprise. In this second example, the individual can use text messaging to order products from the enterprise, to seek technical support from the enterprise, to seek product information, and so on.

Text messaging occurs in a variety of formats. For example, text messages may be exchanged as email messages, as Short Message Service (SMS) messages, as instant messenger messages, as chat room messages, or as other types of messages that include textual content.

An enterprise may execute a software application called a “bot” on a server that receives text messages for the enterprise. When the “bot” receives a text message, the “bot” automatically sends a text message that contains an appropriate response to text message. For example, the “bot” may receive, from an individual, a text message that says, “I want to order a pizza.” In this example, the “bot” may automatically send to the individual a text message that says, “What toppings do you want on your pizza?” The individual and the “bot” may exchange text messages in this fashion until the order for the pizza is complete.

The “bot” may use a grammar as part of a process to respond to text messages. The grammar is a set of rules that constitute a model of a language. When the “bot” receives a text message, the “bot” may use the rules of the grammar to identify concepts expressed by the text message. For instance, the “bot” may use the rules of a grammar to construct a parse tree of the text message. The “bot” can use the parse tree to infer that the text message has a certain semantic meaning due to the syntax of the text message. The “bot” may then generate a response based on the semantic meaning of the text message.

### SUMMARY

In general, this disclosure describes techniques of using a grammar to identify concepts expressed by audio messages and text messages and to respond to the concepts expressed by the audio messages and the text messages. As described herein, a server may receive audio messages and text messages. The server may use the same grammar to identify concepts expressed in the audio messages and in the text messages. Consequently, the need for different grammars to identify concepts expressed in audio messages and to identify concepts expressed in text messages may be minimized. After the server identifies a concept expressed in either an audio message or a text message, the server may generate and send an audio message or a text message that includes a response that is responsive to a concept expressed in the audio message or the text message.

The techniques of this disclosure may be conceptualized in many ways. For example, the techniques of this disclosure may be conceptualized as a method for interpreting text messages that comprises storing a grammar that is usable to identify a concept expressed in an utterance. The method also comprises receiving a text message. In addition, the method comprises using the grammar to identify a concept expressed in the text message. Furthermore, the method comprises generating a response that is responsive to the concept expressed in the text message. In addition, the method comprises outputting an output message that includes the response.

The techniques of this disclosure may also be conceptualized as a device that comprises a data storage module that stores a grammar that is usable to identify a concept expressed in an utterance. The device also comprises a text communication module that receives a text message. Moreover, the device comprises a text analysis module that uses the grammar to identify a concept expressed in the text message. In addition, the device comprises a response module that generates and outputs a response that is responsive to the concept expressed in the text message.

In addition, the techniques of this disclosure may be conceptualized as a computer-readable medium that comprises instructions that cause a computer that executes the instructions to store a grammar. The instructions also cause the computer to receive a text message. In addition, the instructions cause the computer to receive an audio message that includes an utterance. The instructions also cause the computer to use the grammar to identify a concept expressed in the text message. In addition, the instructions cause the computer to use the grammar to identify a concept expressed in the utterance. Furthermore, the instructions cause the computer to generate a first response that is responsive to the concept expressed in the text message. In addition, the instructions cause the instructions to generate a second response that is responsive to the concept expressed in the utterance. The instructions also cause the computer to output an output message that includes the first response. Furthermore, the instructions cause the computer to output an output message that includes the second response.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram illustrating an example communication system.

FIG. 2 is a block diagram illustrating example details of a server in the communication system.

FIG. 3 is a flowchart illustrating an example operation of the server.

FIG. 4 is a flowchart illustrating an example operation of a text analysis module of the server.

FIG. 5 is a flowchart illustrating an example operation of the text analysis module to generate a conceptual resource of a node in a parse tree.

### DETAILED DESCRIPTION

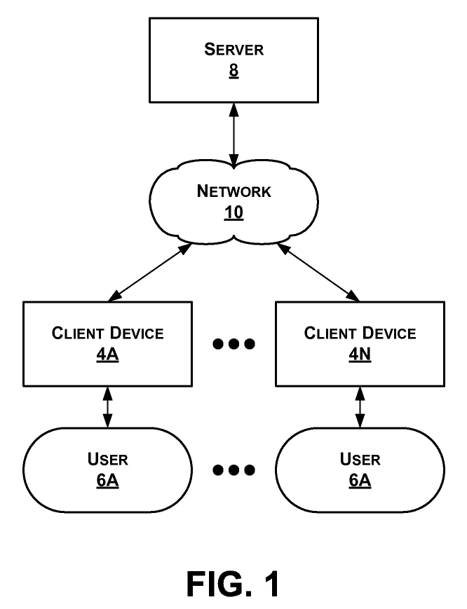

FIG. 1 is a block diagram illustrating an example communication system 2. FIG. 1 is provided for purposes of explanation only and is not intended to represent a sole way of implementing the techniques of this disclosure. Rather, the techniques of this disclosure may be implemented in many ways.

As illustrated in the example of FIG. 1, communication system 2 includes client devices 4A-4N (collectively, “client devices 4”). Client devices 4 may be a wide variety of different types of devices. For example, client devices 4 may be personal computers, laptop computers, mobile telephones, network telephones, personal digital assistants, portable media players, television set top boxes, devices integrated into vehicles, mainframe computers, network appliances, and other types of devices.

Users 6A-6N (collectively, “users 6”) use client devices 4. Although not illustrated in the example of FIG. 1, more than one of users 6 may use a single one of client devices 4.

In addition to client devices 4 and users 6, communication system 2 includes a server 8. Server 8 may be any of a wide variety of different types of network device. For instance, server 8 may be a standalone server device, a server blade in a blade center, a mainframe computer, a personal computer, or another type of network device.

In the example of FIG. 1, communication system 2 includes a network 10 that facilitates communication between client devices 4 and server 8. Network 10 may be one of many different types of network. For instance, network 10 may be a local area network, a wide area network (e.g., the Internet), a global area network, a metropolitan area network, or another type of network. Network 10 may include many network devices and many network links. The network devices in network 10 may include bridges, hubs, switches, firewalls, routers, load balancers, and other types of network devices. The network links in network 10 may include wired links (e.g., coaxial cable, fiber optic cable, 10BASE-T cable, 100BASE-TX cable, etc.) and may include wireless links (e.g., WiFi links, WiMax links, wireless broadband links, mobile telephone links, Bluetooth links, infrared links, etc.).

Each of client devices 4 and server 8 may execute an instance of a messaging application. Users 6 may use the instances of the messaging application to send text messages to each other and to server 8. As used in this disclosure, a “text message” is a message that contains text. It should be appreciated that in some implementations, server 8 may be a considered a “peer” of client devices 4 in the sense that server 8 may act as a server to client devices 6 and may act as a client to any of client devices 4. In other implementations, server 8 may act exclusively as a server.

When the instance of the messaging application on server 8 receives a text message from one of client devices 4, server 8 uses a grammar to identify concepts expressed by the text message. In one example implementation, server 8 may embody an identified concept as a conceptual resource that represents one or more concepts expressed by the text message that are derivable from the syntax of the text message. As used in this disclosure, a conceptual resource is a data structure that stores a representation of a concept in a way that is easily processed by a computer. For instance, a text message may describe a pizza. In this instance, a conceptual resource that represents concepts expressed by the text message may be an extensible markup language (XML) element named “pizza” having attributes such as “topping,” “size,” and “crust type.” In this instance, when server 8 receives a text message “large pan crust pizza with pepperoni,” server 8 may generate a conceptual resource in which the attribute “topping” is equal to “pepperoni,” the attribute “size” is equal to “large,” and the attribute “crust type” is equal to “pan.”

As described in detail below, the grammar used by server 8 may also be used to identify concepts expressed in utterances. For example, server 8 may generate conceptual resources that represent concepts expressed in utterances. In this example, example, the grammar used by server 8 to generate conceptual resources expressed by text messages may be a speech-recognition grammar. An example standard for speech-recognition grammars is outlined in the “Speech Recognition Grammar Specification Version 1.0 W3C Recommendation 16 Mar. 2004” by the World Wide Web Consortium (W3C), the entire content of which is hereby incorporated by reference. In accordance with this standard, grammars may be expressed an XML elements or in augmented Backus-Naur form. In this example, server 8 may generate conceptual resources that conform to the format described in the “Natural Language Semantics Markup Language for the Speech Interface Framework, W3C Working Draft 20 Nov. 2000” by the W3C, the entire content of which is hereby incorporated by reference. As used in this disclosure, an “utterance” is a vocalization of an expression.

After server 8 identifies a concept expressed by the text message, server 8 may perform one or more actions in response to the concept. For instance, server 8 may automatically generate a response to the concept expressed by the text message. By automatically responding to text messages sent by users of client devices 4, server 8 may act as a “bot” that is capable of holding dialogues with the users of client devices 4. In another example, when server 8 determines that a text message expresses an order for a product, server 8 may initiate a process to fulfill the order.

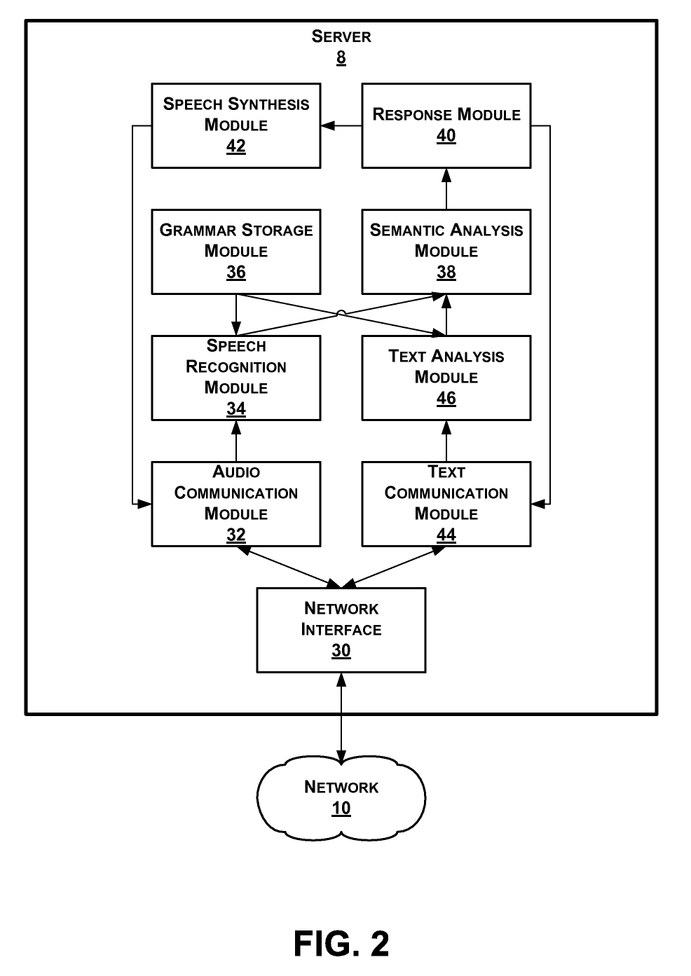

FIG. 2 is a block diagram illustrating example details of server 8. As illustrated in the example of FIG. 2, server 8 includes a network interface 30 that is capable of receiving data from network 10 and capable of sending data on network 10. For instance, network interface 30 may be an Ethernet card, a fiber optic card, a token ring card, a modem, or another type of network interface.

In the example of FIG. 2, server 8 includes an audio communication module 32 that receives audio messages received from network 10 by network interface 30. Audio communication module 32 may be a software module that handles the setup and teardown of an audio communication session and the encoding and decoding of audio messages. For example, audio communication module 32 may be a computer telephony integration application that enables server 8 to receive a stream of audio data through a telephone line. In another example, audio communication module 32 may be a Voice over Internet Protocol (VoIP) client that receives a stream of audio data through an Internet connection. In yet another example, audio communication module 32 may be an application that receives files that contain audio messages. In this example, audio communication module 32 may be an email client that receives email messages to which files that contain audio messages have been attached.

When audio communication module 32 receives an audio message, audio communication module 32 forwards the audio message to a speech recognition module 34. Speech recognition module 34 may use a grammar to generate a conceptual resource that represents concepts expressed by an utterance in the audio message that are derivable from the syntax of the utterance. A grammar storage module 36 may store this grammar.

A grammar models a language by specifying a set of rules that define legal expressions in the language. In other words, an expression in a language is legal if the expression complies with all of the rules in the grammar for the language. For example, a grammar may be used to define all legal expressions in the computer programming language Java. In another example, a grammar may be used to define all the legal expressions the English language. In yet another, a grammar may be used to define all legal expression in the English language that relate to a particular situation.

Each rule in a grammar may include one or more terminal symbols (also known as “tokens”) and/or one or more non-terminal symbols. A terminal symbol is a sequence of one or more characters. A non-terminal symbol is a reference to a grammar rule in the grammar. For example, the following example is a very basic grammar that defines legal expressions in a language:

Pizza→Topping pizza

Topping→pepperoni|sausage

This example grammar includes two rules, “Pizza” and “Topping.” In this example, terminal symbols are shown in bold and non-terminal symbols are shown in italic. In this example, the name of the non-terminal symbol “Topping” in rule “Pizza” is the same as the name of the “Topping” rule in the grammar. This indicates that an expression that conforms to the “Pizza” rule must include an expression that conforms to the “Topping” rule followed by the word “pizza.” In this example, only the terminal symbols “pepperoni” and “sausage” conform to the “Topping” rule. Hence, for the rule “Pizza ” to be satisfied, the word “pepperoni” or the word “sausage” must appear immediately before the word “pizza.” Therefore, the expressions “pepperoni pizza” and “sausage pizza” are the only legal expressions in the language modeled by the example grammar.

Parse trees may be used to characterize how expressions relate to a grammar. In particular, each node in a parse tree of an expression represents an application of a rule in a grammar. The root node of a complete parse tree represents an application of a start rule of a grammar, the leaf nodes of a complete parse tree are applications of rules in the grammar that specify terminal symbols, and intermediate nodes of a complete parse tree represent applications of non-starting rules in the grammar. An incomplete parse tree has leaf nodes that do not specify terminal symbols. For instance, the following example complete parse tree characterizes the expression “pepperoni pizza” in the grammar of the previous paragraph:

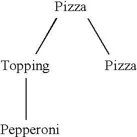

In this example, that there is no way to build a complete parse tree that characterizes the expression “Hawaiian pizza.”

When given an expression, one can determine whether the expression is a legal expression in a language by attempting to identify a complete parse tree for the expression. For example, in a top-down algorithm, one can take the first word of an expression and identify a first set of complete or incomplete parse trees. The first set of parse trees is a set of parse trees that includes all possible parse trees that allow the first word to be the first word of an expression. Next, one can take the second word of the expression and identify a second set of parse trees. The second set of parse trees is a set of parse trees that includes only those parse trees in the first set of parse trees that allow the second word to be the second word of an expression. This may continue until either: 1) all n words in the expression have been taken and there is a complete parse tree in the n^{th} set of parse trees; or 2) there are no complete parse trees in the n^{th} set of parse trees after n words in the expression have been taken. If, after all n words in the expression have been taken and the n^{th} set of parse trees includes at least one complete parse tree, the expression is a legal expression. Otherwise, the expression is an illegal expression. Other algorithms for identifying parse trees for expressions include bottom-up algorithms and algorithms that combine top-down and bottom-up techniques.

One challenge in speech recognition is the identification of words represented by sounds in an audio signal. The identification of words represented by sounds in an audio signal is difficult because people pronounce the same words differently. For instance, people speak at different pitches and at different speeds. Accordingly, the waveform of a sound that represents a word is different when the word is spoken by different people. Therefore, a computer cannot be entirely certain that a received waveform represents a particular word. Rather, the computer can determine the probability that the received waveform represents the particular word. In other words, the computer can calculate the probability of word X given the occurrence of waveform Y.

Moreover, certain words in a language cannot follow other words in the language. For example, in English, the word “wants” cannot follow the word “I.” Therefore, if one assumes that a phrase is being spoken properly in the English, one can assume that the phrase “I wants” is very unlikely. For this reason, the computer can determine that the probability that a waveform represents the word “want” is greater than the probability that the waveform represents the word “wants” when the previous word is “I.”

A grammar can be used to concisely specify which words can follow other words. For instance, if a computer assumes that utterances are being spoken properly in English, the computer may determine that the probability of a waveform representing an utterance is greater when the utterance conforms to an English language grammar than when the utterance does not conform to the English language grammar.

Moreover, grammars can be written that specify legal expressions that can be used in certain situations. Such grammars may be much simpler than grammars for a complete natural language because only a limited number of words and concepts are ever used in a given situation. Grammars that are specialized to certain situations are referred to herein as “situational grammars.” For example, “tomato” and “taupe” are valid terminal symbols in a grammar that specifies valid expressions in the English language, but a situational grammar that specifies valid expressions for ordering pizzas in the English language may include the terminal symbol “tomato,” but not the terminal symbol “taupe.”

Furthermore, because a situational grammar includes a limited number of terminal symbols as compared to a general-purpose grammar, a situational grammar may be helpful in identifying terminal symbols based on their constituent phonemes (i.e., distinct acoustical parts of words). Continuing the previous example, the terminal symbol “tomato” may be subdivided into the phonemes “t,” “ow,” “m,” “ey,” “t,” and “ow” and the terminal symbols “taupe” may be subdivided into the phonemes “t,” “ow,” and “p.” In this example, a computer using the pizza-ordering grammar may determine that the probability that a received waveform represents the phoneme “m” is greater than the probability that the received waveform represents the phoneme “p” when the previous two phonemes were “t” and “ow” because there is no terminal symbol in the pizza-ordering grammar that starts with the phonemes “t,” “ow,” and “p.”

In order to use a grammar to generate a conceptual resource that represents concepts expressed by an utterance, speech recognition module 34 may use the grammar to build one or more parse trees that characterize the utterance. For example, speech recognition module 34 may determine that there is a 0.6 probability that a first waveform represents the word “pepperoni.” In this example, speech recognition module 34 may build all possible parse trees that allow the first word of the expression to be “pepperoni.” In the grammar described above, there is only one possible such parse tree. In this parse tree, the only possible word that can follow “pepperoni” is “pizza.” Therefore, speech recognition module 34 may determine that the probability of a second waveform representing the word “pizza” is greater than the probability of the waveform representing any other word.

Speech recognition module 34 may use the parse tree of an utterance to identify concepts expressed by the utterance. In the previous example, the expression “pepperoni pizza” is allowable because the terminal symbol “pepperoni” is an expression that conforms to the “Topping” rule and because the terminal symbol “pizza” follows an expression that conforms to the “Topping” rule, thus satisfying the “Pizza” rule. In this example, the fact that “pepperoni” is an expression that conforms to the “Topping” rule may effectively indicate to speech recognition module 34 that the terminal symbol “pepperoni” expresses the concept of particular type of a topping for a pizza.

The W3C recommendation “Semantic Interpretation for Speech Recognition (SISR) version 1.0. ” issued 5 Apr. 2007, hereby incorporated in its entirety by reference, outlines one technique whereby the syntax of an utterance, as defined by a grammar, can be used to generate conceptual resources that represent semantic concepts expressed by the utterance. As described in this recommendation, each rule of a grammar outputs an element having one or more attributes. Furthermore, a first rule may map an element outputted by a second rule to an attribute of the output element of the first rule or may map a value associated with a terminal symbol to an attribute of the output element of the first rule. Ultimately, the output element of the start rule of the grammar is a conceptual resource that represents semantic concepts expressed by an utterance.

For example, an XML schema may specify that an element of type “pizza” must include an element of type “topping.” Furthermore, a grammar may be expressed as:

```
<rule id=”pizza”>
      <ruleref uri=”#topping”/>
      <tag>out.topping=rules.topping;</tag>
      pizza
</rule>
<rule id=”topping”>
      <one-of>
            <item>pepperoni<tag>out=”pepperoni”</tag></item>
            <item>sausage<tag>out=”sausage”</tag></item>
      </one-of>
</rule>
```

This example grammar includes two rules: a rule having an id equal to “pizza” (i.e., the pizza rule) and a second rule having an id equal to “topping” (i.e., the topping rule). The pizza rule requires the word “pizza” to follow a string that conforms to the topping rule. Furthermore, the pizza rule includes a tag that specifies that the topping element of a pizza element is equal to the output of the “topping” rule. The topping rule requires either the word “pepperoni” or the word “sausage.” Furthermore, the topping rule includes a tag that specifies that the output of the topping rule is equal to “pepperoni” when the word “pepperoni” is received and includes a tag that specifies that the output of the topping rule is equal to “sausage” when the word “sausage” is received. Using this example grammar, speech recognition module 34 may output the following XML element of type “Pizza” when speech recognition module 34 receives an audio message that includes the utterance “pepperoni pizza”:

<Pizza>
<Topping>pepperoni</Topping>
</Pizza>

In many circumstances, the syntax of an utterance is insufficient to fully understand the semantic meaning of the utterance. For instance, the full meaning of an utterance may require knowledge about the speaker, knowledge about the meaning of other utterances, knowledge about the stress placed on words in the utterance, and so on. Consequently, conceptual resources generated by speech recognition module 34 may not include sufficient information to fully describe the semantic meaning of an expression that is allowable in the grammar. For example, a speaker may say “I want a pizza delivered to my house. I live at 123 Maple Street.” In this example, speech recognition module 34 may use a grammar to build the following parse tree for the first sentence:

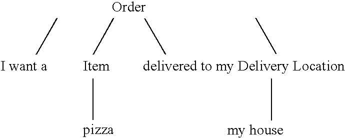

In addition, speech recognition module 34 may use the grammar to build the following parse tree for the second sentence:

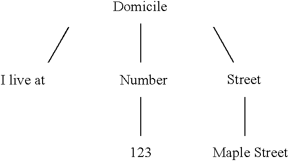

Based on this parse tree, speech recognition module 34 may output the following XML elements:

```
<Order>
      <Item>pizza</Item>
      <Delivery Location>my house</Delivery Location>
</Order>
<Domicile>
      <Number>123</Number>
      <Street>Maple Street</Street>
</Domicile>
```

This information may not be sufficient to understand that “my house” means “123 Maple Street.”

Because the syntax of an utterance may be insufficient to fully understand the semantic meaning of the utterance, server 8 may include a semantic analysis module 38. Semantic analysis module 38 may use conceptual resources generated by speech recognition module 34 to generate one or more conceptual resources that represent concepts expressed by the utterance that are derivable from the syntax of the utterance and concepts expressed by the utterance that are not derivable from the syntax of the utterance. For instance, semantic analysis module 3 8 may use the conceptual resources of the previous example to generate the following conceptual resource:

```
<Order>
      <Item>Pizza</Item>
      <Delivery Location>123 Maple Street</Delivery Location>
</Order>
```

The techniques of this disclosure do not require necessarily require the use of semantic analysis module 34. For instance, when speech recognition module 34 uses a situational grammar that only allows a few valid expressions, the syntax of the utterance may be sufficient to generate useful conceptual resources. However, for ease of explanation, the remainder of the description of FIG. 2 presumes that server 8 includes semantic analysis module 34.

After semantic analysis module 38 generates a conceptual resource, a response module 40 in server 8 may use the conceptual resource in a variety of ways. For example, when semantic analysis module 38 generates a conceptual resource that specifies an order for a pizza, response module 40 may automatically submit the order for a pizza to a local pizzeria that will make and deliver the pizza.

As illustrated in the example of FIG. 2, server 8 may include a speech synthesis module 42. When response module 40 generates a response to a voice message, speech synthesis module 42 may generate a vocalization of the response. For example, when semantic analysis module 38 generates a conceptual resource that specifies an order for a pizza, response module 40 may automatically generate a response that repeats the order back to the customer. In this example, when response module 40 may generate a response that states “Thank you for your order,” speech analysis module 42 generates a vocalization of this response. Speech analysis module 42 may use a set of pre-recorded vocalizations to generate the vocalization of the response. After speech synthesis module 42 generates the vocalization, speech synthesis module 42 may provide the vocalization to audio communication module 32. Audio communication module 32 may then use network interface 30 to send the vocalization to a device that sent the original audio message.

As illustrated in the example of FIG. 2, server 8 may include a text communication module 44 that receives text messages that network interface 30 received from network 10. Text communication module 44 may be a variety of different types of application that receive different types of text messages. For example, text communication module 44 may be an instant messenger application such as “Windows Live Messenger” produced by Microsoft Corporation of Redmond, Wash., “AOL Instant Messenger” produced by America Online, LLC of New York, N.Y., “Yahoo! Messenger” produced by Yahoo! Inc, of Santa Clara, Calif., “ICQ” produced by America Online, LLC of New York, N.Y., “iChat” produced by Apple, Inc. of Cupertino, Calif., or another type of instant message application. In another example, text communication module 44 may be an email application such as the OUTLOOK® messaging and collaboration client produced by Microsoft Corporation or a web-based email application such as the HOTMAIL® web-based e-mail service produced by Microsoft Corporation. In another example, text communication module 44 may be a network chat application such as an Internet Relay Chat client or a web-based chat room application. In yet another example, text communication module 44 may a Short Message Service (SMS) client. Furthermore, text communication module 44 may be part of an application that also includes audio communication module 32. For instance, Windows Live Messenger supports both text messages and audio messages.

When text communication module 44 receives a text message, text communication module 44 provides the text message to a text analysis module 46. Text analysis module 46 uses the grammar to generate a conceptual resource that represents concepts expressed by the text message that are derivable from the syntax of the text message. A conceptual resource that represents a concept expressed by the text message may be substantially the same as the conceptual resource that represents the concept expressed in an utterance. For example, text analysis module 46 may generate the conceptual resource

<Pizza>
<Topping>pepperoni</Topping>
</Pizza>

when text communication module 44 receives the expression “pepperoni pizza” in a text message. In this example, speech recognition module 34 may also generate the conceptual resource

<Pizza>
<Topping>pepperoni</Topping>
</Pizza>

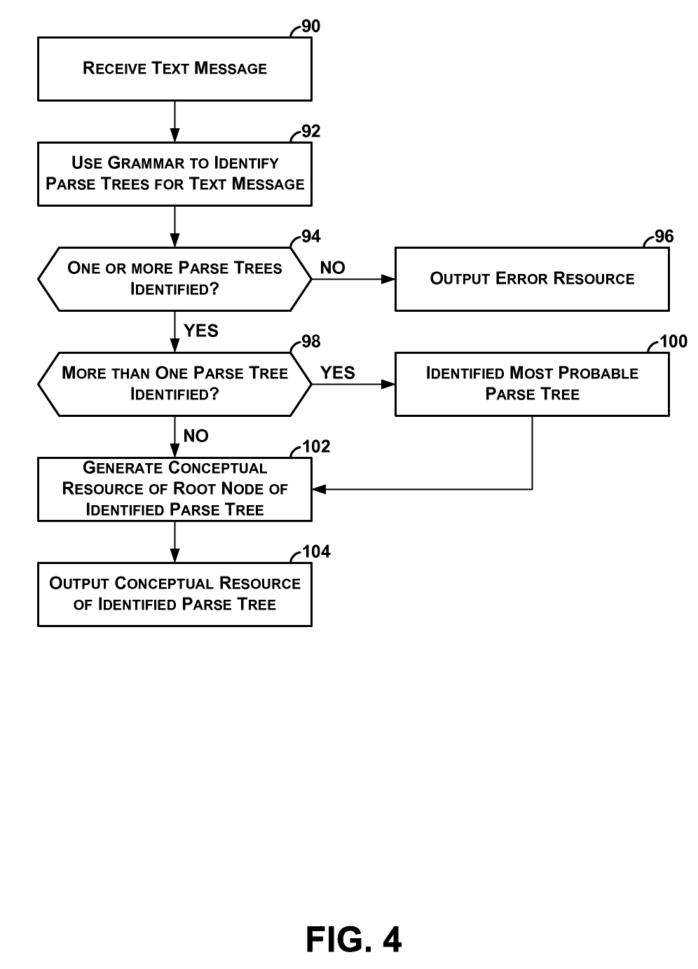

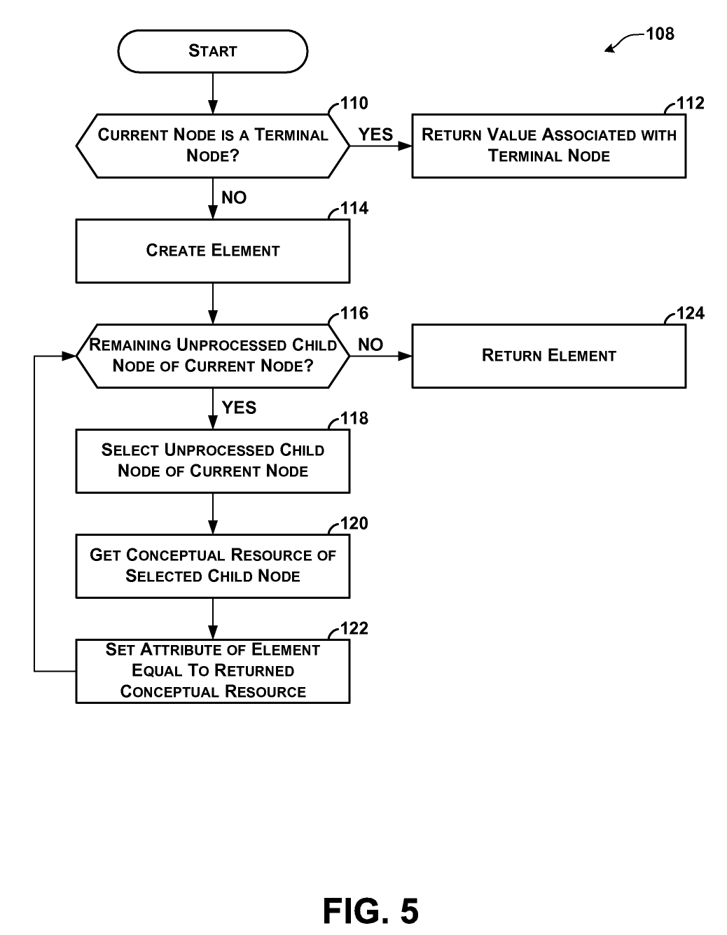

when audio communication module 32 receives the expression “pepperoni pizza” in an audio message. FIGS. 4 and 5, described in detail below, illustrate example operations that text analysis module 46 may use to generate a conceptual resource that represents concepts expressed by the text message that are derivable from the syntax of the text message.

After text analysis module 46 generates a conceptual resource that represents concepts expressed by a text message that are derivable from the syntax of the text message, semantic analysis module 38 may use the conceptual resource to generate one or more conceptual resources that represent concepts expressed by the text message that are derivable from the syntax of the text message and concepts expressed by the text message that are not derivable from the syntax of the text message. In this way, semantic analysis module 38 may generate conceptual resources that represent concepts expressed in text messages and audio messages. Furthermore, response module 40 may generate responses based on conceptual resources generated by semantic analysis module 38, regardless of whether the conceptual resources are based on concepts expressed by text messages or audio messages.

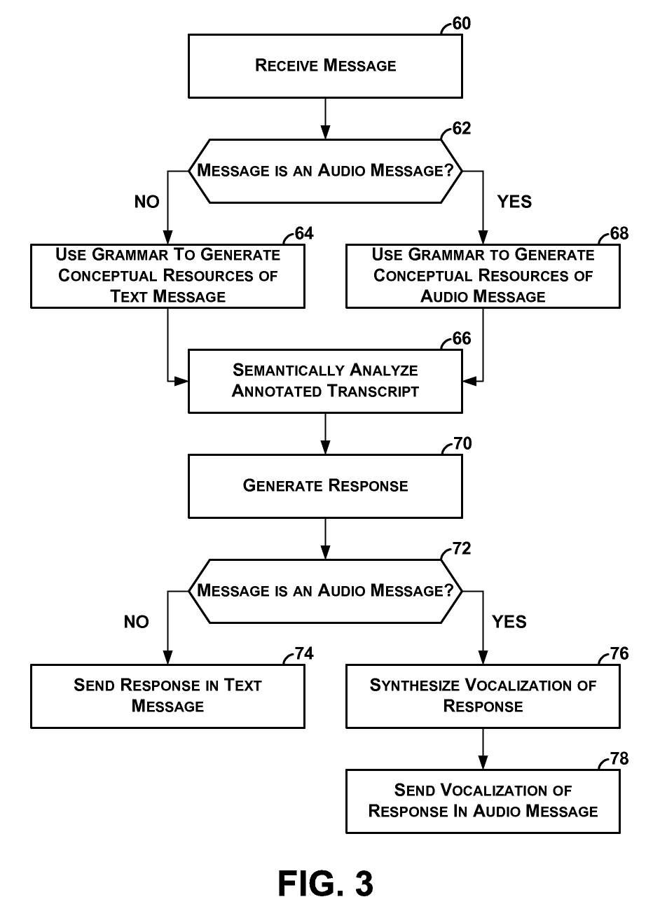

FIG. 3 is a flowchart illustrating an example operation of server 8. As illustrated in the example of FIG. 3, the operation may begin when network interface 30 receives a message (60). When network interface 30 receives the message, an operating system of server 8 may determine whether the message is an audio message (62).

In the example of FIG. 3, if the message is not an audio message (“NO” of 62), the message may be considered to be a text message. If the message is a text message, text communication module 44 may use a grammar stored in grammar storage module 36 to generate one or more conceptual resources that represent concepts expressed by the text message that are derivable from the syntax of the text message (64). After text communication module 44 generates the conceptual resources, semantic analysis module 38 may use the conceptual resources to generate one or more conceptual resources that represent concepts expressed by the text message that are derivable from the syntax of the text message and concepts expressed by the text message that are not derivable from the syntax of the text message (66).

On the other hand, if the message received by network interface 30 is an audio message (“YES” of 62), speech recognition module 34 may use the grammar to generate one or more conceptual resources that represent concepts expressed by an utterance in the audio message that are derivable from the syntax of the utterance (68). After speech recognition module 34 generates the conceptual resources, semantic analysis module 38 may generate one or more conceptual resources that represent concepts expressed by the utterance that are derivable from the syntax of the utterance and concepts expressed by the utterance that are not derivable from the syntax of the utterance (66).

When semantic analysis module 38 generates a set of conceptual resources that represent concepts expressed in a message received by network interface 30, response module 40 may use the conceptual resources to generate a response (70). After response module 40 generates the response, response module 40 may determine whether the message received by network interface 30 is an audio message (72).

If the message is not an audio message (i.e., the message is a text message) (“NO” of 72), text communication module 44 uses network interface 30 to output the response generated by response module 40 as a text message (74).

If the message is an audio message (“YES” of 72), speech synthesis module 42 may generate a vocalization of the response generated by response module 40 (76). After speech synthesis module 42 generates the vocalization, audio communication module 32 may use network interface 30 to output the vocalization as an audio message (78).

FIG. 3 is provided for explanatory purposes only and is not intended to depict a sole possible operation of server 8. Rather server 8 may perform many other operations. For example, server 8 may perform an operation that is similar to the operation in FIG. 3, does not allow server 8 to receive, process, or send audio messages.

FIG. 4 is a flowchart illustrating an example operation of text analysis module 46. As illustrated in the example of FIG. 4, the operation may begin when text analysis module 46 receives a text message (90). When text analysis module 46 receives a text message, text analysis module 46 may use the grammar to identify complete parse trees for the text message (92). As discussed above, text analysis module 46 may use a bottom-up algorithm, a top-down algorithm, or some other type of algorithm to identify the complete parse trees for the text message. After text analysis module 46 identifies the parse trees, text analysis module 46 may determine whether one or more parse trees have been identified (94).

If text analysis module 46 determines that fewer than one parse trees were identified (“NO” of 94), text analysis module 46 may output an error resource (96). The error resource may indicate that the text message is not a legal expression in the grammar. Response module 40 may perform a variety of actions when text analysis module 46 outputs an error resource. For instance, response module 40 may generate a response that asks the sender of the text message to rephrase the expression.

On the other hand, if text analysis module 46 determines that one or more parse tree were identified (“YES” of 94), text analysis module 46 may determine whether more than one parse tree was identified (98). If more than one parse tree was identified (“YES” of 98), there is an ambiguity in the grammar. In other words, there may be more than one legal interpretation of the text message. Consequently, text analysis module 46 may identify a most probable one of the identified parse trees (100). Text analysis module 46 may determine the relative probabilities of the parse trees based on a variety of factors including past experience, the relative number of nodes in the parse trees, and so on.

After text analysis module 46 identifies the most probable one of the identified parse trees or after text analysis module 46 determines that only one complete parse tree was identified (“NO” of 98), text analysis module 46 may invoke a method to generate the conceptual resource of the root node of the identified parse tree (102). FIG. 5, discussed below, illustrates an example recursive operation that returns the conceptual resource of a node in a parse tree. After generating the conceptual resource of the root node of the identified parse tree, text analysis module 46 may output the conceptual resource of the root node of the identified parse tree (104).

FIG. 5 is a flowchart illustrating an example operation 108 of text analysis module 46 to generate a conceptual resource of a current node in a parse tree. As discussed above, each node in a parse tree represents an application of a rule in the grammar. In the example of FIG. 5, text analysis module 46 may begin the operation by determining whether the current node of the parse tree is a terminal node (110). If the current node is a terminal node (“YES” of 110), text analysis module 46 returns a value associated with the terminal node (112). For example, if the terminal node is associated with the value “pepperoni,” text analysis module 46 returns the value “pepperoni.”

On the other hand, if the current node is not a terminal node (i.e., the current node is a non-terminal node) (“NO” of 110), text analysis module 46 may create a new element of a type associated with the non-terminal node (114). For example, if the current node represents an application of the “Pizza” rule of the previous examples, text analysis module 46 may create a “Pizza” element that includes a “Topping” attribute.

After creating the element, text analysis module 46 may determine whether there are any remaining unprocessed child nodes of the current node (116). For example, immediately after text analysis module 46 created the “Pizza” element in the previous example, the current node had one unprocessed child node: “Topping.” If text analysis module 46 determines that there is a remaining unprocessed child node of the current node (“YES” of 116), text analysis module 46 may select one of the unprocessed child nodes of the current node (118). Text analysis module 46 may then recursively perform operation 108 to generate the conceptual resource of the selected child node (120). In other words, the operation illustrated in FIG. 5 is repeated with respect to the selected child node. After text analysis module 46 generates the conceptual resource of the selected child node, text analysis module 46 may set one of the attributes of the element equal to the conceptual element of the selected child node (122). In this way, text analysis module 46 processes the child node of the current node. Next, text analysis module 46 may loop back and again determine whether there are any remaining unprocessed child nodes of the current node (116).

If there are no remaining unprocessed child nodes of the current node (“NO” of 116), text analysis module 46 may return the element (124).

The techniques of this disclosure may provide one or more advantages. For instance, the techniques of this disclosure may be advantageous because the techniques may eliminate the need to create separate grammars to identify concepts expressed by text messages and concepts expressed by utterances. Not having to create separate grammars may be more efficient, saving time and money. Furthermore, because the same grammar can be used to create conceptual resources that represent concepts expressed by text messages and conceptual resources that represent concepts expressed by utterances, server 8 may produce identical conceptual resources when server 8 receives a text message the expresses a concept and an utterance that expresses the same concept. Consequently, server 8 may not need to execute different software to use conceptual resources based on text messages and utterances.

It is to be understood that the embodiments described herein may be implemented by hardware, software, firmware, middleware, microcode, or any combination thereof When the systems and/or methods are implemented in software, firmware, middleware or microcode, program code or code segments, they may be stored in a machine-readable medium, such as a storage component. A code segment may represent a procedure, a function, a subprogram, a program, a routine, a subroutine, a module, a software package, a class, or any combination of instructions, data structures, or program statements A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, etc.

For a software implementation, the techniques described herein may be implemented with modules (e.g., procedures, functions, and so on) that perform the functions described herein. The software codes and instructions may be stored in computer-readable media and executed by processors. The memory unit may be implemented within the processor or external to the processor, in which case it can be communicatively coupled to the processor via various means as is known in the art.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for interpreting text messages comprising:
storing a grammar that is usable to identify a concept expressed in an utterance;
receiving a text message;
using the grammar to identify a concept expressed in the text message;
generating a response that is responsive to the concept expressed in the text message; and
outputting an output message that includes the response.

2. The method of claim 1, wherein the grammar is a speech recognition grammar specification grammar as defined in the World-Wide-Web Consortium Speech Recognition Grammar Specification Version 1.0.

3. The method of claim 2, wherein the grammar is expressed as a set of Extensible Markup Language (XML) elements.

4. The method of claim 2, wherein the grammar is expressed in an augmented Backus-Naur Form.

5. The method of claim 1,
wherein receiving the text message comprises receiving a first instant message; and
wherein outputting the output message comprises outputting a second instant message that includes the response.

6. The method of claim 1,
wherein receiving the text message comprises receiving a first Short Message Service (SMS) message; and
wherein outputting the output message comprises outputting a second SMS message that includes the response.

7. The method of claim 1,
wherein receiving the text message comprises receiving a first email; and
wherein outputting the output message comprises outputting a second email that includes the response.

8. The method of claim 1, wherein the concept is derivable from a syntax of the text message.

9. The method of claim 1, wherein using the grammar to identify the concept expressed in the text message comprises using the grammar to generate a conceptual resource that represents the concept expressed in the text message.

10. The method of claim 9, wherein using the grammar to identify the concept expressed in the text message comprises:
using rules of the grammar to generate a parse tree of the text message; and
generating a conceptual resource associated with a root node of the parse tree.

11. The method of claim 9, wherein the conceptual resource is an XML element.

12. (canceled)

12. A device comprising:
a data storage module that stores a grammar that is usable to identify a concept expressed in an utterance;
a text communication module that receives a text message;
a text analysis module that uses the grammar to identify a concept expressed in the text message; and
a response module that generates and outputs a response that is responsive to the concept expressed in the text message.

13. The device of claim 12, wherein the grammar conforms to a Speech Recognition Grammar Specification promulgated by the World Wide Web Consortium.

14. The device of claim 12, wherein the text message is an instant message and the output message is an instant message.

15. The device of claim 12, wherein the concept is derivable from a syntax of the text message.

16. (canceled)

17. The device of claim 12, wherein the text analysis module uses rules of the grammar to generate a parse tree of the text message and generate a conceptual resource associated with a root node of the parse tree.

18. The device of claim 12,
wherein the response is a first response and the output message is a first output message; and
wherein the device further comprises:
an audio communication module that receives an audio message that includes the utterance; and
a speech recognition module that uses the grammar to identify the concept expressed in the utterance; and
wherein the response module generates a second response that is responsive to the concept expressed in the utterance and outputs an output message that includes the second response.

19. A computer-readable medium comprising instructions that cause a computer that executes the instructions to:
store a grammar that is usable to identify concepts expressed in utterances and concepts expressed in text messages;
receive an instant messenger message;
receive an audio message that includes an utterance;
use the grammar to construct a first parse tree of the instant messenger message;
use the grammar to generate a first conceptual resource that represents a concept expressed in the instant messenger message, wherein attributes of the first conceptual resource are associated with non-terminal symbols of the first parse tree;
use the grammar to construct a second parse tree of the utterance;
use the grammar to generate a second conceptual resource that represents a concept expressed in the text message, wherein attributes of the second conceptual resource are associated with non-terminal symbols of the second parse tree;
use the first conceptual resource to generate a first response that is responsive to the concept expressed in the instant messenger message;
use the second conceptual resource to generate a second response that is responsive to the concept expressed in the utterance;
output an output message that includes the first response; and
output an output message that includes the second response.

20. The computer-readable medium of claim 19, wherein the instructions that cause the computer to use the grammar to generate the first conceptual resource comprise instructions that cause the computer to:
determine whether a node in the first parse tree is a non-terminal node;
generate a new conceptual resource of a type associated with the node when the node is a non-terminal node;
generate a conceptual resource for each child node of the node in the first parse tree when the node is a non-terminal node; and
set attributes of the new conceptual resource based on the conceptual resources of the child nodes when the node is a non-terminal node.

21. The method of claim 1,
wherein the response is a first response and the output message is a first output message; and
wherein the method further comprises:
receiving an audio message that includes the utterance;
using the grammar to identify the concept expressed in the utterance;
generating a second response that is responsive to the concept expressed in the utterance; and
outputting a second output message that includes the second response.
